(19) United States
(12) Patent Application Publication
(10) Pub. No.: US 2025/0378548 A1
(43) Pub. Date: Dec. 11, 2025

(54) PARAMETERIZED INSPECTION IMAGE SIMULATION

(71) Applicant: ASML Netherlands B.V., Veldhoven (NL)

(72) Inventors: Rui YUAN, Santa Clara, CA (US); Chi-Hsiang FAN, Santa Clara, CA (US); Yi-Hsin CHANG, Milpitas, CA (US); Fuming WANG, Santa Clara, CA (US); Yun LIN, San Jose, CA (US); Abdalmohsen ELMALK, Los Altos, CA (US)

(73) Assignee: ASML Netherlands B.V., Veldhoven (NL)

(21) Appl. No.: 18/876,196

(22) PCT Filed: Sep. 13, 2023
(86) PCT No.: PCT/EP2023/075167

§ 371 Date: Dec. 18, 2024

Related U.S. Application Data
(60) Provisional application No. 63/411,040, filed on Sep. 28, 2022.

(51) Int. Cl. G06T 7/00; G06T 5/80; G06T 7/13; G06T 11/60; G06V 10/44

(52) U.S. Cl. CPC G06T 7/001; G06T 5/80; G06T 7/0006; G06T 7/13; G06T 11/60; G06V 10/44; G06T 2207/10061

(57) ABSTRACT

An improved method, apparatus, and system for generating a simulated inspection image are disclosed. According to certain aspects, the method comprises acquiring design data including a first pattern, generating a first gray level profile corresponding to the design data, and rendering an image using the generated first gray level profile.

### CROSS-REFERENCE TO RELATED APPLICATIONS

This application claims priority of U.S. application 63/411,040 which was filed on September 28, 2022 and which is incorporated herein in its entirety by reference.

### TECHNICAL FIELD

The embodiments provided herein relate to an inspection image simulation technology, and more particularly to parameterized simulated inspection image generation from a layout design.

### BACKGROUND

In manufacturing processes of integrated circuits (ICs), unfinished or finished circuit components are inspected to ensure that they are manufactured according to design and are free of defects. Inspection systems utilizing optical microscopes or charged particle (e.g., electron) beam microscopes, such as a scanning electron microscope (SEM) can be employed. As the physical sizes of IC components continue to shrink, accuracy and yield in defect detection become more important. Various metrology tools are developed and used to check whether the ICs are correctly manufactured. To improve defect inspection performance, verifying/quantifying such metrology tools with a sufficient number of inspection images with various patterns, sizes, and densities is desired.

### SUMMARY

The embodiments provided herein disclose a particle beam inspection apparatus, and more particularly, an inspection apparatus using a plurality of charged particle beams.

Some embodiments provide an apparatus for generating a simulated inspection image. The apparatus can comprise a memory storing a set of instructions; and at least one processor configured to execute the set of instructions to cause the apparatus to perform: acquiring design data including a first pattern; generating a first gray level profile corresponding to the design data; and rendering an image using the generated first gray level profile.

Some embodiments provide a non-transitory computer readable medium that stores a set of instructions that is executable by at least on processor of a computing device to cause the computing device to perform a method for generating a simulated inspection image. The method comprises acquiring design data including a first pattern; generating a first gray level profile corresponding to the design data; and rendering an image using the generated first gray level profile.

Other advantages of the embodiments of the present disclosure will become apparent from the following description taken in conjunction with the accompanying drawings wherein are set forth, by way of illustration and example, certain embodiments of the present invention.

### BRIEF DESCRIPTION OF FIGURES

The above and other aspects of the present disclosure will become more apparent from the description of exemplary embodiments, taken in conjunction with the accompanying drawings.

FIG. 1 is a schematic diagram illustrating an example charged-particle beam inspection system, consistent with embodiments of the present disclosure.

FIG. 2 is a schematic diagram illustrating an example multi-beam tool that can be a part of the example charged-particle beam inspection system of FIG. 1, consistent with embodiments of the present disclosure.

FIG. 3 is a block diagram of an example inspection image simulation system, consistent with embodiments of the present disclosure.

FIGS. 4A-4D illustrate an example procedure of inspection image simulation, consistent with embodiments of the present disclosure.

FIG. 5 is a block diagram of an example gray level profile generation system, consistent with embodiments of the present disclosure.

FIGS. 6A-6C illustrates an example procedure of gray level profile generation, consistent with embodiments of the present disclosure.

FIG. 7A illustrates an example performance evaluation of inspection image simulation system consistent with embodiments of the present disclosure.

FIGS. 7B-7C illustrate example simulation images of various patterns generated using inspection image simulation system consistent with embodiments of the present disclosure.

FIG. 8 is a process flowchart representing an example method for simulating inspection image, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of apparatuses and methods consistent with aspects related to the disclosed embodiments as recited in the appended claims. For example, although some embodiments are described in the context of utilizing electron beams, the disclosure is not so limited. Other types of charged-particle beams (e.g., including protons, ions, muons, or any other particle carrying electric charges) may be similarly applied. Furthermore, other imaging systems may be used, such as optical imaging, photon detection, x-ray detection, ion detection, etc.

Electronic devices are constructed of circuits formed on a piece of semiconductor material called a substrate. The semiconductor material may include, for example, silicon, gallium arsenide, indium phosphide, or silicon germanium, or the like. Many circuits may be formed together on the same piece of silicon and are called integrated circuits or ICs. The size of these circuits has decreased dramatically so that many more of them can be fit on the substrate. For example, an IC chip in a smartphone can be as small as a thumbnail and yet may include over 2 billion transistors, the size of each transistor being less than 1/1000th the size of a human hair.

Making these ICs with extremely small structures or components is a complex, time-consuming, and expensive process, often involving hundreds of individual steps. Errors in even one step have the potential to result in defects in the finished IC, rendering it useless. Thus, one goal of the manufacturing process is to avoid such defects to maximize the number of functional ICs made in the process; that is, to improve the overall yield of the process.

One component of improving yield is monitoring the chip-making process to ensure that it is producing a sufficient number of functional integrated circuits. One way to monitor the process is to inspect the chip circuit structures at various stages of their formation. Inspection can be carried out using a scanning charged-particle microscope (SCPM). For example, an SCPM may be a scanning electron microscope (SEM). A SCPM can be used to image these extremely small structures, in effect, taking a “picture” of the structures of the wafer. The image can be used to determine if the structure was formed properly in the proper location. If the structure is defective, then the process can be adjusted, so the defect is less likely to recur.

As the physical sizes of IC components continue to shrink, accuracy and yield in defect detection become more important. Metrology tools can be used to determine whether the ICs are correctly manufactured by measuring critical dimensions, curvatures, roughness, etc. of structures on wafer. Such metrology can be based on contour of structures extracted by a contour extraction tool that can be part of some of metrology tools. Accurately verifying/quantifying metrology tools is important to improve defect inspection accuracy. Further, various metrology tools have been developed, and which metrology tool to use among the various metrology tools can be determined based on their performance, e.g., accuracy, throughput, etc. Because the metrology tool performance can be different per pattern, size, density, etc., testing metrology tools with a sufficient number of inspection images with various patterns, sizes, and densities is desired to accurately verify/quantify metrology tools. However, acquiring a sufficient number of inspection images with various patterns, sizes, and densities is time consuming and costly, or even impossible.

While there are several SCPM simulators on the market, e.g., Hyperlith and eScatter, these simulators are based on physical modeling of beams. Such physical model-based simulators are generally time inefficient, or even impossible to generate a sufficient number of simulated SCPM images with various patterns, sizes, and densities. Moreover, outputs of these SCPM simulators are not compatible with some metrology tools.

Embodiments of the present disclosure can provide a parameterized SCPM image simulator. According to some embodiments of the present disclosure, simulated inspection images incorporating metrology related parameters that a user can define and determine. According to some embodiments of the present disclosure, a simulated inspection image can be generated utilizing gray level profile data extracted from real images (i.e., non-simulation images) or physical model-based simulation images, or utilizing user defined gray level profile data. In some embodiments, gray level profile data can be from user defined gray level profile data. According to some embodiments of the present disclosure, a simulated inspection image can be controlled using parameters related to edge roughness, gray level profile, distortion, contrast, etc. According to some embodiments of the present disclosure, an inspection image having complicated patterns can be simulated, which the existing physical model-based simulator may not be able to accomplish. According to some embodiments of the present disclosure, an inspection image can be simulated much faster than the existing physical model-based simulator.

Relative dimensions of components in drawings may be exaggerated for clarity. Within the following description of drawings, the same or like reference numbers refer to the same or like components or entities, and only the differences with respect to the individual embodiments are described. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

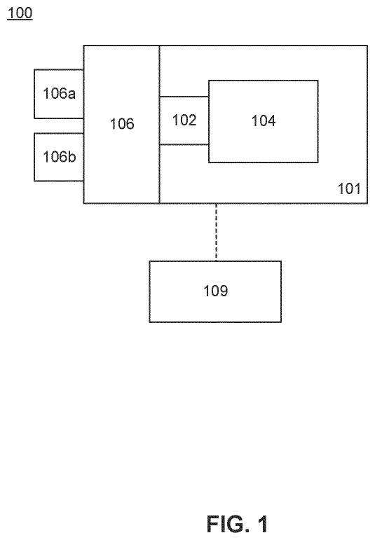

FIG. 1 illustrates an example electron beam inspection (EBI) system 100 consistent with embodiments of the present disclosure. EBI system 100 may be used for imaging. As shown in FIG. 1, EBI system 100 includes a main chamber 101, a load/lock chamber 102, a beam tool 104, and an equipment front end module (EFEM) 106. Beam tool 104 is located within main chamber 101. EFEM 106 includes a first loading port 106a and a second loading port 106b. EFEM 106 may include additional loading port(s). First loading port 106a and second loading port 106b receive wafer front opening unified pods (FOUPs) that contain wafers (e.g., semiconductor wafers or wafers made of other material(s)) or samples to be inspected (wafers and samples may be used interchangeably). A “lot” is a plurality of wafers that may be loaded for processing as a batch.

One or more robotic arms (not shown) in EFEM 106 may transport the wafers to load/lock chamber 102. Load/lock chamber 102 is connected to a load/lock vacuum pump system (not shown) which removes gas molecules in load/lock chamber 102 to reach a first pressure below the atmospheric pressure. After reaching the first pressure, one or more robotic arms (not shown) may transport the wafer from load/lock chamber 102 to main chamber 101. Main chamber 101 is connected to a main chamber vacuum pump system (not shown) which removes gas molecules in main chamber 101 to reach a second pressure below the first pressure. After reaching the second pressure, the wafer is subject to inspection by beam tool 104. Beam tool 104 may be a single-beam system or a multi-beam system.

A controller 109 is electronically connected to beam tool 104. Controller 109 may be a computer configured to execute various controls of EBI system 100. While controller 109 is shown in FIG. 1 as being outside of the structure that includes main chamber 101, load/lock chamber 102, and EFEM 106, it is appreciated that controller 109 may be a part of the structure.

In some embodiments, controller 109 may include one or more processors (not shown). A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, controller 109 may further include one or more memories (not shown). A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes and data may include an operating system (OS) and one or more application programs (or “apps”) for specific tasks. The memory may also be a virtual memory that includes one or more memories distributed across multiple machines or devices coupled via a network.

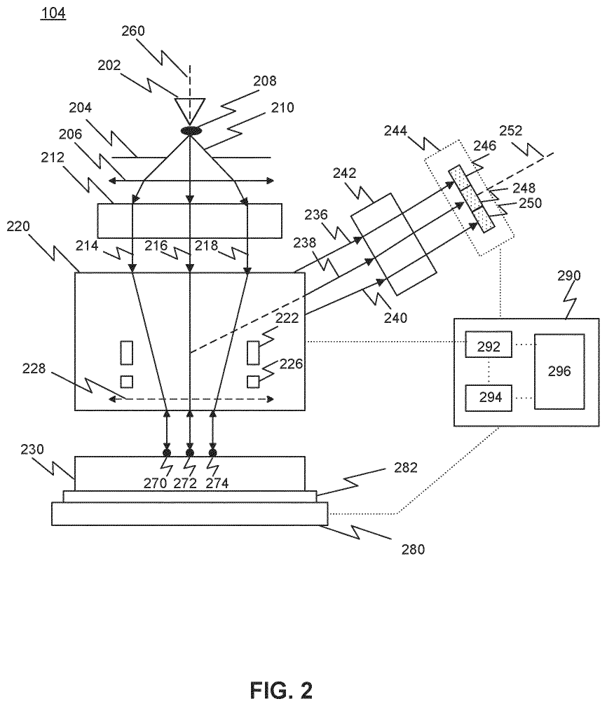

FIG. 2 illustrates a schematic diagram of an example multi-beam tool 104 (also referred to herein as apparatus 104) and an image processing system 290 that may be configured for use in EBI system 100 (FIG. 1), consistent with embodiments of the present disclosure.

Beam tool 104 comprises a charged-particle source 202, a gun aperture 204, a condenser lens 206, a primary charged-particle beam 210 emitted from charged-particle source 202, a source conversion unit 212, a plurality of beamlets 214, 216, and 218 of primary charged-particle beam 210, a primary projection optical system 220, a motorized wafer stage 280, a wafer holder 282, multiple secondary charged-particle beams 236, 238, and 240, a secondary optical system 242, and a charged-particle detection device 244. Primary projection optical system 220 can comprise a beam separator 222, a deflection scanning unit 226, and an objective lens 228. Charged-particle detection device 244 can comprise detection sub-regions 246, 248, and 250. 35

Charged-particle source 202, gun aperture 204, condenser lens 206, source conversion unit 212, beam separator 222, deflection scanning unit 226, and objective lens 228 can be aligned with a primary optical axis 260 of apparatus 104. Secondary optical system 242 and charged-particle detection device 244 can be aligned with a secondary optical axis 252 of apparatus 104.

Charged-particle source 202 can emit one or more charged particles, such as electrons, protons, ions, muons, or any other particle carrying electric charges. In some embodiments, charged-particle source 202 may be an electron source. For example, charged-particle source 202 may include a cathode, an extractor, or an anode, wherein primary electrons can be emitted from the cathode and extracted or accelerated to form primary charged-particle beam 210 (in this case, a primary electron beam) with a crossover (virtual or real) 208. For ease of explanation without causing ambiguity, electrons are used as examples in some of the descriptions herein. However, it should be noted that any charged particle may be used in any embodiment of this disclosure, not limited to electrons. Primary charged-particle beam 210 can be visualized as being emitted from crossover 208. Gun aperture 204 can block off peripheral charged particles of primary charged-particle beam 210 to reduce Coulomb effect. The Coulomb effect may cause an increase in size of probe spots.

Source conversion unit 212 can comprise an array of image-forming elements and an array of beam-limit apertures. The array of image-forming elements can comprise an array of micro-deflectors or micro-lenses. The array of image-forming elements can form a plurality of parallel images (virtual or real) of crossover 208 with a plurality of beamlets 214, 216, and 218 of primary charged-particle beam 210. The array of beam-limit apertures can limit the plurality of beamlets 214, 216, and 218. While three beamlets 214, 216, and 218 are shown in FIG. 2, embodiments of the present disclosure are not so limited. For example, in some embodiments, the apparatus 104 may be configured to generate a first number of beamlets. In some embodiments, the first number of beamlets may be in a range from 1 to 1000. In some embodiments, the first number of beamlets may be in a range from 200-500. In an exemplary embodiment, an apparatus 104 may generate 400 beamlets.

Condenser lens 206 can focus primary charged-particle beam 210. The electric currents of beamlets 214, 216, and 218 downstream of source conversion unit 212 can be varied by adjusting the focusing power of condenser lens 206 or by changing the radial sizes of the corresponding beam-limit apertures within the array of beam-limit apertures. Objective lens 228 can focus beamlets 214, 216, and 218 onto a wafer 230 for imaging, and can form a plurality of probe spots 270, 272, and 274 on a surface of wafer 230.

Beam separator 222 can be a beam separator of Wien filter type generating an electrostatic dipole field and a magnetic dipole field. In some embodiments, if they are applied, the force exerted by the electrostatic dipole field on a charged particle (e.g., an electron) of beamlets 214, 216, and 218 can be substantially equal in magnitude and opposite in a direction to the force exerted on the charged particle by magnetic dipole field. Beamlets 214, 216, and 218 can, therefore, pass straight through beam separator 222 with zero deflection angle. However, the total dispersion of beamlets 214, 216, and 218 generated by beam separator 222 can also be non-zero. Beam separator 222 can separate secondary charged-particle beams 236, 238, and 240 from beamlets 214, 216, and 218 and direct secondary charged-particle beams 236, 238, and 240 towards secondary optical system 242.

Deflection scanning unit 226 can deflect beamlets 214, 216, and 218 to scan probe spots 270, 272, and 274 over a surface area of wafer 230. In response to the incidence of beamlets 214, 216, and 218 at probe spots 270, 272, and 274, secondary charged-particle beams 236, 238, and 240 may be emitted from wafer 230. Secondary charged-particle beams 236, 238, and 240 may comprise charged particles (e.g., electrons) with a distribution of energies. For example, secondary charged-particle beams 236, 238, and 240 may be secondary electron beams including secondary electrons (energies≤50 eV) and backscattered electrons (energies between 50 eV and landing energies of beamlets 214, 216, and 218). Secondary optical system 242 can focus secondary charged-particle beams 236, 238, and 240 onto detection sub-regions 246, 248, and 250 of charged-particle detection device 244. Detection sub-regions 246, 248, and 250 may be configured to detect corresponding secondary charged-particle beams 236, 238, and 240 and generate corresponding signals (e.g., voltage, current, or the like) used to reconstruct an SCPM image of structures on or underneath the surface area of wafer 230.

The generated signals may represent intensities of secondary charged-particle beams 236, 238, and 240 and may be provided to image processing system 290 that is in communication with charged-particle detection device 244, primary projection optical system 220, and motorized wafer stage 280. The movement speed of motorized wafer stage 280 may be synchronized and coordinated with the beam deflections controlled by deflection scanning unit 226, such that the movement of the scan probe spots (e.g., scan probe spots 270, 272, and 274) may orderly cover regions of interests on the wafer 230. The parameters of such synchronization and coordination may be adjusted to adapt to different materials of wafer 230. For example, different materials of wafer 230 may have different resistance-capacitance characteristics that may cause different signal sensitivities to the movement of the scan probe spots.

The intensity of secondary charged-particle beams 236, 238, and 240 may vary according to the external or internal structure of wafer 230, and thus may indicate whether wafer 230 includes defects. Moreover, as discussed above, beamlets 214, 216, and 218 may be projected onto different locations of the top surface of wafer 230, or different sides of local structures of wafer 230, to generate secondary charged-particle beams 236, 238, and 240 that may have different intensities. Therefore, by mapping the intensity of secondary charged-particle beams 236, 238, and 240 with the areas of wafer 230, image processing system 290 may reconstruct an image that reflects the characteristics of internal or external structures of wafer 230.

In some embodiments, image processing system 290 may include an image acquirer 292, a storage 294, and a controller 296. Image acquirer 292 may comprise one or more processors. For example, image acquirer 292 may comprise a computer, server, mainframe host, terminals, personal computer, any kind of mobile computing devices, or the like, or a combination thereof. Image acquirer 292 may be communicatively coupled to charged-particle detection device 244 of beam tool 104 through a medium such as an electric conductor, optical fiber cable, portable storage media, IR, Bluetooth, internet, wireless network, wireless radio, or a combination thereof. In some embodiments, image acquirer 292 may receive a signal from charged-particle detection device 244 and may construct an image. Image acquirer 292 may thus acquire SCPM images of wafer 230. Image acquirer 292 may also perform various post-processing functions, such as generating contours, superimposing indicators on an acquired image, or the like. Image acquirer 292 may be configured to perform adjustments of brightness and contrast of acquired images. In some embodiments, storage 294 may be a storage medium such as a hard disk, flash drive, cloud storage, random access memory (RAM), other types of computer-readable memory, or the like. Storage 294 may be coupled with image acquirer 292 and may be used for saving scanned raw image data as original images, and post-processed images. Image acquirer 292 and storage 294 may be connected to controller 296. In some embodiments, image acquirer 292, storage 294, and controller 296 may be integrated together as one control unit.

In some embodiments, image acquirer 292 may acquire one or more SCPM images of a wafer based on an imaging signal received from charged-particle detection device 244. An imaging signal may correspond to a scanning operation for conducting charged particle imaging. An acquired image may be a single image comprising a plurality of imaging areas. The single image may be stored in storage 294. The single image may be an original image that may be divided into a plurality of regions. Each of the regions may comprise one imaging area containing a feature of wafer 230. The acquired images may comprise multiple images of a single imaging area of wafer 230 sampled multiple times over a time sequence. The multiple images may be stored in storage 294. In some embodiments, image processing system 290 may be configured to perform image processing steps with the multiple images of the same location of wafer 230.

In some embodiments, image processing system 290 may include measurement circuits (e.g., analog-to-digital converters) to obtain a distribution of the detected secondary charged particles (e.g., secondary electrons). The charged-particle distribution data collected during a detection time window, in combination with corresponding scan path data of beamlets 214, 216, and 218 incident on the wafer surface, can be used to reconstruct images of the wafer structures under inspection. The reconstructed images can be used to reveal various features of the internal or external structures of wafer 230, and thereby can be used to reveal any defects that may exist in the wafer.

In some embodiments, the charged particles may be electrons. When electrons of primary charged-particle beam 210 are projected onto a surface of wafer 230 (e.g., probe spots 270, 272, and 274), the electrons of primary charged-particle beam 210 may penetrate the surface of wafer 230 for a certain depth, interacting with particles of wafer 230. Some electrons of primary charged-particle beam 210 may elastically interact with (e.g., in the form of elastic scattering or collision) the materials of wafer 230 and may be reflected or recoiled out of the surface of wafer 230. An elastic interaction conserves the total kinetic energies of the bodies (e.g., electrons of primary charged-particle beam 210) of the interaction, in which the kinetic energy of the interacting bodies does not convert to other forms of energy (e.g., heat, electromagnetic energy, or the like). Such reflected electrons generated from elastic interaction may be referred to as backscattered electrons (BSEs). Some electrons of primary charged-particle beam 210 may inelastically interact with (e.g., in the form of inelastic scattering or collision) the materials of wafer 230. An inelastic interaction does not conserve the total kinetic energies of the bodies of the interaction, in which some or all of the kinetic energy of the interacting bodies convert to other forms of energy. For example, through the inelastic interaction, the kinetic energy of some electrons of primary charged-particle beam 210 may cause electron excitation and transition of atoms of the materials. Such inelastic interaction may also generate electrons exiting the surface of wafer 230, which may be referred to as secondary electrons (SEs). Yield or emission rates of BSEs and SEs depend on, e.g., the material under inspection and the landing energy of the electrons of primary charged-particle beam 210 landing on the surface of the material, among others. The energy of the electrons of primary charged-particle beam 210 may be imparted in part by its acceleration voltage (e.g., the acceleration voltage between the anode and cathode of charged-particle source 202 in FIG. 2). The quantity of BSEs and SEs may be more or fewer (or even the same) than the injected electrons of primary charged-particle beam 210.

The images generated by SCPM may be used for defect inspection. For example, a generated image capturing a test device region of a wafer may be compared with a reference image capturing the same test device region. The reference image may be predetermined (e.g., by simulation) and include no known defect. If a difference between the generated image and the reference image exceeds a tolerance level, a potential defect may be identified. For another example, the SCPM may scan multiple regions of the wafer, each region including a test device region designed as the same, and generate multiple images capturing those test device regions as manufactured. The multiple images may be compared with each other. If a difference between the multiple images exceeds a tolerance level, a potential defect may be identified.

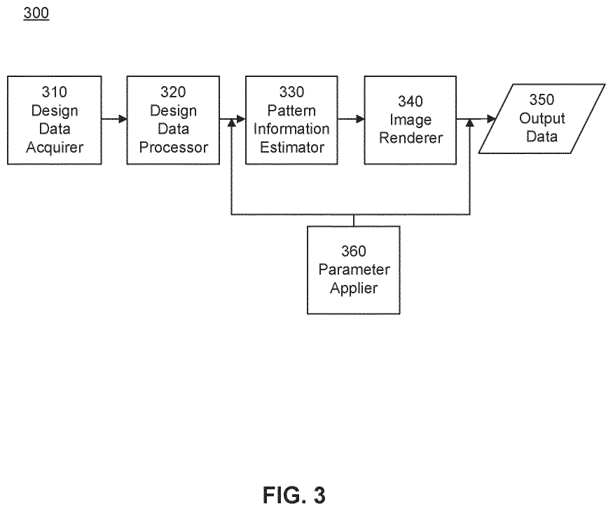

Reference is now made to FIG. 3, which is a block diagram of an example inspection image simulation system, consistent with embodiments of the present disclosure. Inspection image simulation system 300 (also referred to as “apparatus 300”) can comprise one or more computers, servers, mainframe hosts, terminals, personal computers, any kind of mobile computing devices, and the like, or combinations thereof. It is appreciated that in various embodiments inspection image simulation system 300 may be part of or may be separate from a charged-particle beam inspection system (e.g., EBI system 100 of FIG. 1). It is also appreciated that inspection image simulation system 300 may include one or more components or modules separate from and communicatively coupled to the charged-particle beam inspection system. In some embodiments, inspection image simulation system 300 may include one or more components (e.g., software modules) that can be implemented in controller 109 or system 290 as discussed herein. As shown in FIG. 3, inspection image simulation system 300 may comprise a design data acquirer 310, a design data processor 320, a pattern information estimator 330, and an image renderer 340. According to some embodiments, inspection image simulation system 300 can further comprise a parameter applier 360.

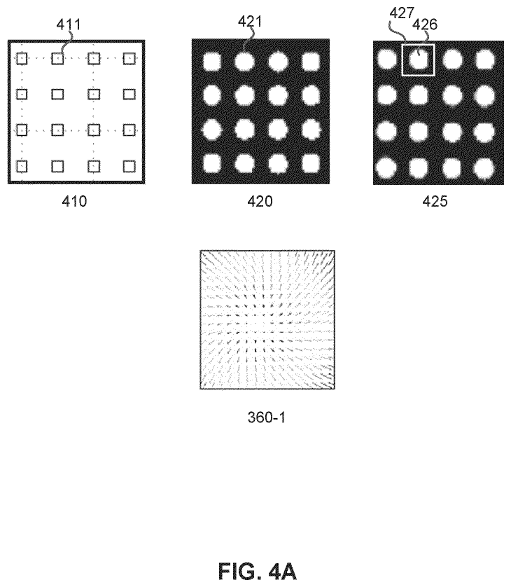

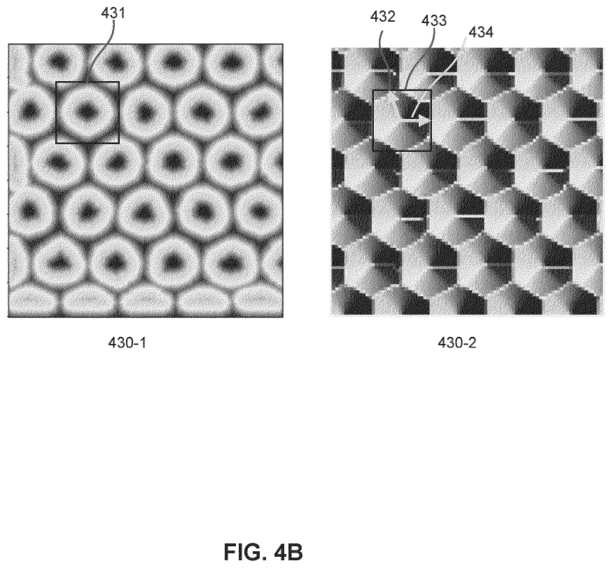

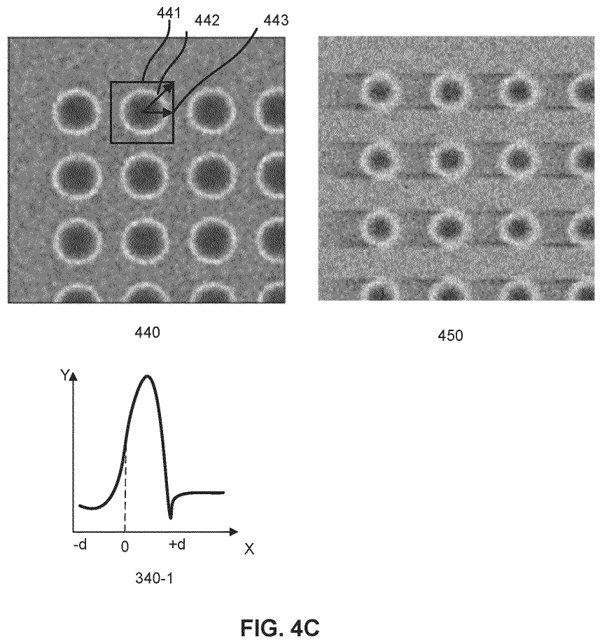

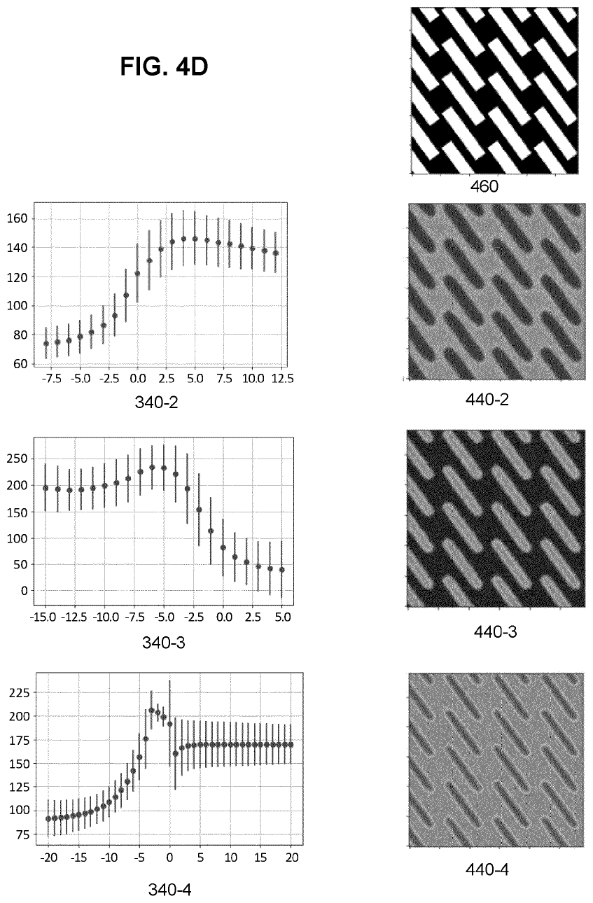

According to some embodiments of the present disclosure, design data acquirer 310 can acquire design data having a certain pattern. Design data can be a layout file for a wafer design, which is a golden image or in a Graphic Database System (GDS) format, Graphic Database System II (GDS II) format, an Open Artwork System Interchange Standard (OASIS) format, a Caltech Intermediate Format (CIF), etc. The wafer design may include patterns or structures for inclusion on the wafer. The patterns or structures can be mask patterns used to transfer features from the photolithography masks or reticles to a wafer. In some embodiments, a layout in GDS or OASIS format, among others, may comprise feature information stored in a binary file format representing planar geometric shapes, text, and other information related to the wafer design. FIG. 4A illustrates design data 410. As shown in FIG. 4A, design data 410 includes a pattern 411. In some embodiments, a user can generate design data 410 to include pattern(s) with a designated shape, size, density, etc. In some embodiments, a user can select a certain portion of design data 410 having pattern(s) with a designated shape, size, density, etc.

Referring back to FIG. 3, design data processor 320 can perform an image processing operation to design data 410 acquired by design data acquirer 310. In some embodiments, design data processor 320 can transform design data 410 into a binary image. In some embodiments, design data processor 320 can further perform a corner rounding on the binary image. FIG. 4A illustrates a binary image 420, which is obtained after performing a corner rounding on a binary image transformed from design data 410. In some embodiments, a corner rounding operation can be performed to emulate a pattern formed on a wafer. In FIG. 4A, binary image 420 includes a pattern 421 corresponding to pattern 411 of design data 410. As shown in FIG. 4A, corners of pattern 421 on binary image 420 are rounded compared to corners of pattern 411 on design data 410. While a corner rounding is illustrated as an image processing operation, it will be appreciated that any image processing operations to mimic patterns formed on wafer can be performed to design data 410. For example, pattern merging or pattern cropping can be performed on binary image 420.

According to some embodiments of the present disclosure, one or more parameters can be applied by parameter applier 360 to incorporate properties that real SCPM images would have. According to some embodiments of the present disclosure, inspection image simulation system 300 can take into account parameters to emulate SCPM images including certain metrology related properties such as roughness, charging effect, distortion, gray level profile, voltage contrast, etc. In some embodiments, a charging effect can be applied to binary image 420 by parameter applier 360. A charging effect can cause image distortion when structures of wafer comprise insulating materials. An image distortion model 360-1 representing the charging effect over binary image 420 can be applied by parameter applier 360 to binary image 420. In some embodiments, a charging effect can be applied by adjusting distortion parameters of image distortion model 360-1 corresponding to the charging effect.

In some embodiments, image distortion model 360-1 representing a distortion map can be adjusted by changing parameters related to a rotation degree, a scale, shift, etc. In this stage, a charging effect can be applied per field of view (FOV) of processed binary image 425. In some embodiments, distortion model 360-1 can be established based on observing real SCPM images, structures on wafer, materials constituting the structures, inspection conditions, etc. In some embodiments, image distortion model 360-1 can represent a distortion map caused by any reasons other than a charging effect. FIG. 4A illustrates processed binary image 425, which is obtained after applying image distortion model 360-1 to binary image 420. In FIG. 4A, processed binary image 425 includes a pattern 426 corresponding to pattern 421 of binary image 420. As shown in FIG. 4A, a shape or location of pattern 426 on processed binary image 425 can be different from that of pattern 421 due to the introduction of distortion representing a charging effect. While subsequent processes to be performed by inspection image simulation system 300 will be illustrated with processed binary image 425, it will be appreciated that the subsequent processes can be performed to binary image 420 when distortion model 360-1 is not applied to binary image 420.

In some embodiments, one or more image processes including distortion model 360-1 application can be applied to binary image 425 to incorporate one or more parameters into a simulated inspection image. In this example, processed binary image 425 of FIG. 4A shows the resultant processed binary image that is acquired by applying roughness to contours and image distortion model 360-1 to binary image 420. In some embodiments, roughness to contours can be modeled to be applied by parameter applier 360. In some embodiments, roughness can be modeled using a power spectral density (PSD) function. In some embodiments, roughness can be applied by adjusting parameters of a roughness model according to the desired level of roughness. For example, the roughness model can be adjusted by changing parameters of the PSD function such as a standard deviation, a longitudinal correlation coefficient, a slope coefficient, etc. It will be noted that any model representing roughness to contours can be utilized in this disclosure. In this disclosure, processed binary image 425 can refer to the resultant image after performing one or more image processes to binary image 420.

Referring back to FIG. 3, pattern information estimator 330 can estimate pattern information from processed binary image 425. In some embodiments, pattern information estimator 330 can estimate distance information of pattern 426. In some embodiments, distance information of pattern 426 can be estimated by performing a distance transformation operation on processed binary image 425. A distance transformation converts processed binary image 425, consisting of feature and non-feature pixels, into an image where all non-feature pixels have a value corresponding to the distance to the nearest feature pixel. In some embodiments, pixels constituting a contour of pattern 426 can be recognized as feature pixels. FIG. 4B illustrates a distance image 430-1 estimated from processed binary image 425. In FIG. 4B, distance image 430-1 includes a section 431 corresponding to a section 427 including pattern 426 in processed binary image 425 of FIG. 4A. In FIG. 4B, distance image 430-1 gets brighter as the distance from the nearest feature pixel (i.e., contour of pattern 426) becomes shorter. Distance image 430-1 gets darker as the distance from the nearest feature pixel (i.e., contour of pattern 426) becomes longer. Therefore, as shown in FIG. 4B, distance image 430-1 is brighter along the circular contour of pattern 426 and it gets darker as the distance from the contour increases. According to some embodiments, distance image 430-1 can be used to determine a distance of a certain pixel in section 431 from the contour of pattern 426. For example, positions of all pixels in section 431 can be defined by a distance from the contour of pattern 426. In some embodiments, distance image 430-1 can show whether a certain pixel in section 431 is positioned inside of the contour of pattern 426 or outside of pattern 426. For example, distance image 430-1 can use a different color for a pixel positioned inside of the contour of pattern 426 from a color used for a pixel positioned outside of the contour. In some embodiments, while brightness represents a distance magnitude of a certain pixel, a color can show whether the pixel is positioned inside or outside of the contour of the pattern. In some embodiments, a negative sign (−) can be used when a certain pixel is positioned inside of the contour of pattern 426 and a positive sign (+) can be used when a certain pixel is positioned outside of the contour of pattern 426. While obtaining distance information is described with respect to one pattern (e.g., 426), it will be appreciated distance information can be obtained for any or all patterns on processed binary image 425 in a similar manner.

In some embodiments, pattern information estimator 330 can estimate degree information of pattern 426 from distance image 430-1 of FIG. 4B. In some embodiments, degree information of pattern 426 can be estimated by performing a gradient operation on distance image 430-1. In some embodiments, by performing a gradient operation on distance image 430-1, the direction of greatest change on distance image 430-1 can be obtained. FIG. 4B illustrates gradient image 430-2 that is obtained by performing a gradient operation on distance image 430-1. As shown in FIG. 4B, gradient image 430-2 includes a section 433 corresponding to section 431 of distance image 430-1. As shown in FIG. 4B, gradient image 430-2 shows the direction of greatest change on distance image 430-1. As distance image 430-1 has a distance from the contour of pattern 426 as a pixel value, the direction of greatest change of distance image 430-1 could be perpendicular to the contour of pattern 426. As indicated by direction lines 432 and 434 in gradient image 430-2, a direction of greatest change of distance image 430-1 can be a radial direction in this example. While gradient image 430-2 shows two direction lines 432 and 434, it will be appreciated that gradient image 430-2 can have any number of direction lines indicating the direction of greatest change of distance image 430-1. In some embodiments, a rotation center of direction lines 432 and 434 can be determined based on gradient image 430-2. In this example, the rotation center of direction lines 432 and 434 is the center of section 433. In some embodiments, a reference line extending from the rotation center can be set based on gradient image 430-2 to determine degree information of each pixel in section 433. In this example, direction line 434 can be used as a reference line defining 0°. According to some embodiments, degree information of a certain pixel in section 433 can be determined by a degree of the pixel from a reference line, e.g., reference line 434. For example, a degree of a certain pixel can be determined by an angle between the line from the center to the corresponding pixel and the reference line. While gradient image 430-2 of FIG. 4B illustrates that direction lines range from 0° to 360° (i.e., degree range 360°) , it will be appreciated that the degree range can be different according to pattern shape, gradient image 430-2, etc. For example, a certain pattern may have a degree range less than 360°.

According to some embodiments of the present disclosure, a position of each pixel in section 433 can be determined according to distance information and degree information of section 433. For example, a position of a pixel can be specified as a distance from the contour of pattern 426 and a degree from a reference line. While some embodiments of the present disclosure are illustrated using a circular pattern (e.g., pattern 426), it will be appreciated that the present disclosure can be applied to any shape of patterns having a closed loop pattern. For example, a pixel in a section having any closed loop pattern can be specified by defining the location of the pixel in the section with the distance from the pattern contour and the degree from the reference line. In this disclosure, the close loop pattern can comprise any polygon type pattern, e.g., a rectangular pattern, a star shape pattern, etc. In some embodiments, the close loop pattern can also comprise a line pattern as the line pattern also has a width as well as a length.

Referring back to FIG. 3, image renderer 340 can render a gray level image corresponding to processed binary image 425. According to some embodiments of the present disclosure, image renderer 340 can render an image using gray level profile data corresponding to processed binary image 425. FIG. 4C illustrates a gray level image 440 rendered using gray level profile data 340-1. Gray level profile data 340-1 shown in FIG. 4C is an example gray level profile along a line 442 in section 441. In FIG. 4C, line 442 is 45° from reference line 443, and gray level profile data 340-1 represents a gray level of pixels positioned along line 442. In gray level profile data 340-1 of FIG. 4C, an x-axis represents a distance from a contour of pattern 426 where distance 0 represents the contour of pattern 426 and the distance with the negative symbol (−d) represents a distance d from the contour of pattern inside of pattern 426 and the distance with the positive symbol (+d) represents a distance d from the contour of pattern outside of pattern 426. While FIG. 4C shows gray profile data 340-1 along one line 442 at 45°, it will be appreciated that gray profile data along multiple lines at various degrees are used to generate gray level image of section 441. It will also be appreciated that other sections of gray level image 440 can be rendered in a similar way of generating section 441.

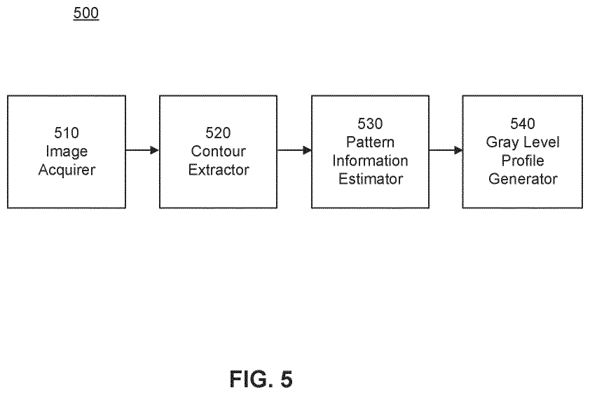

According to some embodiments of the present disclosure, gray level profile data 340-1 can be developed from real SCPM images, simulation images from physical model-based simulators, or user defined gray level profile data. How the gray level profile data is developed will be explained later in the present disclosure referring to FIG. 5. In some embodiments, gray level profile data 340-1 can be modified from gray level profile data extracted from real SCPM images or simulation images from physical model-based simulators, or from user defined gray level profile data. When modifying the existing gray level profile data, a user can change gray level profiles to reflect properties that a user intends to observe from inspection images. In some embodiments, existing gray level profile data developed from SCPM images having different patterns, sizes, or densities from that of design data 410 can be utilized to simulate an inspection image corresponding to design data 410. In this case, the existing gray level profile data can be modified according to differences between design data 410 and SCPM images from which the existing gray level profile data is extracted when rendering an image corresponding to design data 410. According to some embodiments of the present disclosure, gray level profile data 340-1 can be obtained by modifying existing gray level profile data of a non-simulation image or a simulation image having similar pattern type, size, or density with design data 410. Therefore, inspection images with various patterns, sizes, densities, etc. can be simulated according to some embodiments of the present disclosure.

According to some embodiments of the present disclosure, a user can determine which gray level profile data to apply when rendering a gray level image. FIG. 4D illustrates how gray level profile data affects on a rendered gray level image. FIG. 4D shows design data 460 that corresponds to and has a different pattern from design data 410 of FIG. 4A and in a binary image format. In FIG. 4D, three gray level images 440-2, 440-3, and 440-4 that are rendered by applying three different gray level profile data 340-2, 340-3, and 340-4 respectively to design data 460 are shown. For example, gray level image 440-2 is acquired by applying gray level profile data 340-2 to design data 460, and so on. Similar to gray level profile data 340-1 of FIG. 4C, it will be noted that three gray level profile data 340-2, 340-3, and 340-4 of FIG. 4D also show gray level profile data along only one line at a certain degree for one pattern in design data 460. As shown in FIG. 4D, three resultant gray level images 440-2, 440-3, and 440-4 are different from each other. According to some embodiments of the present disclosure, a user can obtain a desired gray level image by adjusting gray level profile data to be applied to design data. While it is not illustrated, it is noted that rendered gray level images 440-2, 440-3, and 440-4 are acquired by applying gray level profile data 340-2, 340-3, and 340-4 to design data 460 after one or more processes are performed to design data 460.

Referring back to FIG. 3, in some embodiments, parameter applier 360 can apply parameters that a user intends to take into account in a simulated inspection image. In some embodiments, a charging effect can be applied to each section 441 on gray level image 440. According to some embodiments, a model representing a charging effect can be applied to gray level image 440. In some embodiments, the charging effect of insulating or the poorly conductive material irradiated by e-beams may affect the resultant SCPM image. A charging effect on SCPM images may lead to certain voltage contrast patterns on SCPM image. In some embodiments, a charging effect can lead to a darker or brighter voltage contrast on SCPM image. In some embodiments, a model representing a charging effect can be generated according to materials forming structures on wafer, a pattern shape, intensity of irradiated beams, a scanning direction, etc. In some embodiments, parameter applier 360 can apply a model representing a charging effect for each section 441 on gray level image 440. In some embodiments, the model representing a charging effect can be adjusted by adjusting parameters related to a charging direction, a tail-length, a contrast value, a gray level value, a pattern contour, etc. FIG. 4C illustrates a resultant gray level image 450 after a charging effect is applied. As shown in FIG. 4C, resultant gray level image 450 is different from gray level image 440 according to the charging effect applied to gray level image 440. For example, resultant gray level image 450 is different from gray level image 440 in various aspects, e.g., contrast, pattern contour, gray level, etc.

In some embodiments, resultant gray level image 450 can be outputted as output data 350 of system 300. In some embodiments, one or more parameters can be applied to resultant gray level image 450 and output data therefrom can be outputted as output data 350 of system 300. In some embodiments, output data 350 can be packed in a certain image format including identification information of a pattern shape, size, density, etc. In some embodiments, output data 350 can be in any other format that can be used in later process, e.g., by a metrology tool.

FIG. 5 is a block diagram of an example gray level profile extraction system 500, consistent with embodiments of the present disclosure. Gray level profile extraction system 500 (also referred to as “apparatus 500”) can comprise one or more computers, servers, mainframe hosts, terminals, personal computers, any kind of mobile computing devices, and the like, or combinations thereof. It is appreciated that in various embodiments, gray level profile extraction system 500 may be part of or may be separate from a charged-particle beam inspection system (e.g., EBI system 100 of FIG. 1). It is also appreciated that gray level profile extraction system 500 may include one or more components or modules separate from and communicatively coupled to the charged-particle beam inspection system. In some embodiments, gray level profile extraction system 500 may include one or more components (e.g., software modules) that can be implemented in controller 109 or system 290 as discussed herein. It is appreciated that in various embodiments, gray level profile extraction system 500 may be part of or may be separate from inspection image simulation system 300 of FIG. 3. As shown in FIG. 5, gray level profile extraction system 500 may comprise an image acquirer 510, a contour extractor 520, a pattern information estimator 530, and a gray level profile generator 540.

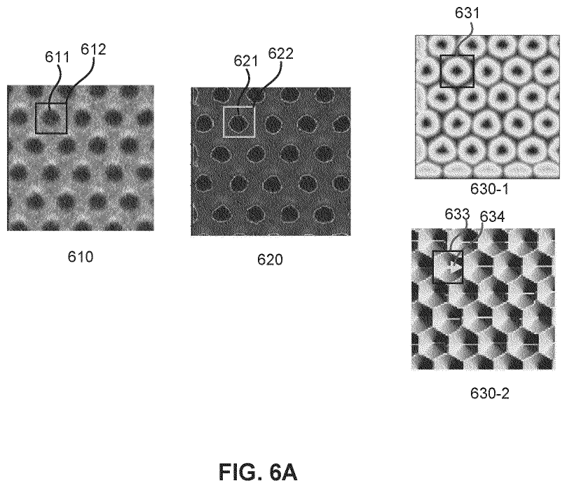

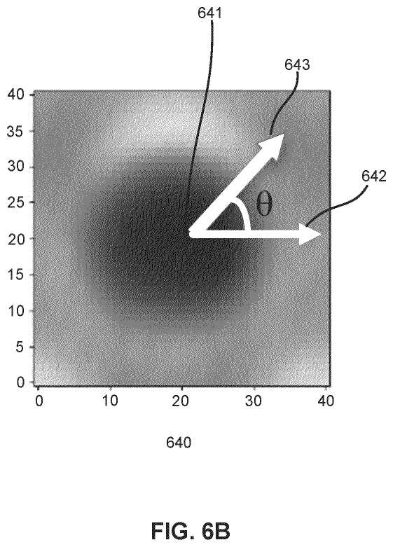

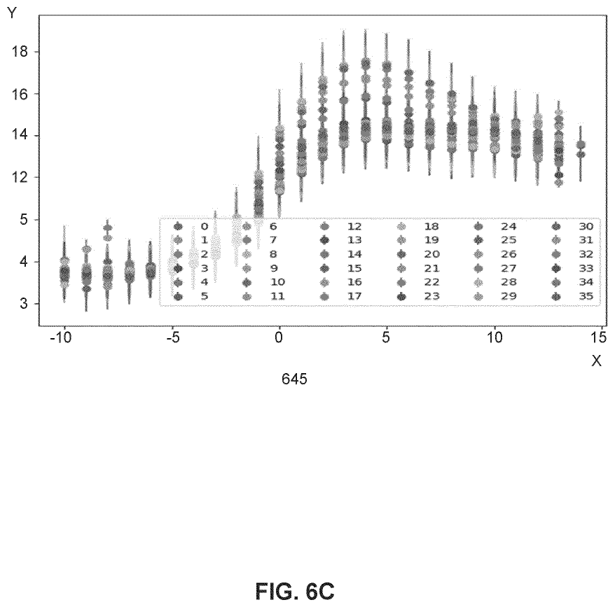

According to some embodiments of the present disclosure, image acquirer 510 can acquire an inspection image as an input image. In some embodiments, an inspection image is a SCPM image of a sample or a wafer. In some embodiments, an inspection image can be an inspection image generated by, e.g., EBI system 100 of FIG. 1 or electron beam tool 104 of FIG. 2. In some embodiments, image acquirer 510 may obtain an inspection image from a storage device or system storing the inspection image. FIG. 6A illustrates an example inspection image 610 including a pattern 611. As shown in FIG. 6A, inspection image 610 may include pattern 611 with a certain shape, a size, and a density.

Referring back to FIG. 5, contour extractor 520 can extract contour information of pattern(s) on inspection image 610. In some embodiments, contour information of pattern 611 can include information of boundary line(s) of pattern 611. In some embodiments, a boundary line of a pattern can be a line for determining an outer shape of the pattern, a line for determining an inner shape of the pattern, a border line between different textures in the pattern, or other types of lines that can be used for recognizing the pattern. FIG. 6A illustrates an example contour extracted image 620 of inspection image 610. As shown in FIG. 6A, a contour 621 of pattern 611 is indicated in contour extracted image 620.

Referring back to FIG. 5, pattern information estimator 530 can estimate pattern information from contour extracted image 620. In some embodiments, pattern information estimator 630 can estimate distance information of pattern 611. In some embodiments, distance information of pattern 611 can be estimated by performing a distance transformation operation on contour extracted image 620. A distance transformation converts contour extracted image 620, consisting of feature and non-feature pixels, into an image where all non-feature pixels have a value corresponding to the distance to the nearest feature pixel. In some embodiments, pixels constituting contour 621 of pattern 611 can be recognized as feature pixels. FIG. 6A illustrates a distance image 630-1 estimated from contour extracted image 620. In FIG. 6A, distance image 630-1 includes a section 631 corresponding to a section 622 including contour 621 in contour extracted image 620. In FIG. 6A, distance image 630-1 gets brighter as the distance from contour 621 becomes shorter. Distance image 630-1 gets darker as the distance from contour 621 becomes longer. Therefore, as shown in FIG. 6A, distance image 630-1 is brighter along the circular contour 621 and it gets darker as the distance from contour 621 increases. According to some embodiments, distance image 630-1 can be used to determine a distance of a certain pixel in section 631 from contour 621 of pattern 611. For example, positions of all pixels in section 631 can be defined by a distance from contour 621 of pattern 611. In some embodiments, distance image 630-1 can show whether a certain pixel in section 631 is positioned inside of contour 621 or outside of contour 621. For example, distance image 630-1 can use a different color for a pixel positioned inside of contour 621 from a color used for a pixel positioned outside of contour 621. In some embodiments, while brightness represents a distance magnitude of a certain pixel, a color can show whether the pixel is positioned inside or outside of the patter contour. In some embodiments, a negative sign (−) can be used when a certain pixel is positioned inside of contour 621 and a positive sign (+) can be used when a certain pixel is positioned outside of contour 621. While obtaining distance information is described with respect to one pattern (e.g., 611), it will be appreciated distance information can be obtained for any or all patterns on contour extracted image 620 in a similar manner.

In some embodiments, pattern information estimator 530 can estimate degree information of pattern 611 from distance image 630-1 in FIG. 6A. In some embodiments, degree information of pattern 611 can be estimated by performing a gradient operation on distance image 630-1. In some embodiments, by performing a gradient operation on distance image 630-1, the direction of greatest change on distance image 630-1 can be obtained. FIG. 6A illustrates gradient image 630-2 that is obtained by performing a gradient operation on distance image 630-1. As shown in FIG. 6A, gradient image 630-2 includes a section 633 corresponding to section 631 of distance image 630-1. As shown in FIG. 6A, gradient image 630-2 shows the direction of greatest change on distance image 630-1. As distance image 630-1 has a distance from contour 621 as a pixel value, the direction of greatest change of distance image 630-1 could be perpendicular to contour 621 of pattern 611. As indicated by a direction line 634 in gradient image 630-2, a direction of greatest change of distance image 630-1 can be a radial direction in this example. While gradient image 630-2 shows one direction line 634, it will be appreciated that direction image 630-2 can have any number of direction lines indicating the direction of greatest change of distance image 630-1. In some embodiments, a rotation center of direction lines 634 can be determined based on gradient image 630-2. In this example, the rotation center of direction lines 634 is the center of section 633. In some embodiments, a reference line extending from the rotation center can be set based on gradient image 630-2 to determine degree information of each pixel in section 633. In this example, direction line 634 can be used as a reference line defining 0°. According to some embodiments, degree information of a certain pixel in section 633 can be determined by a degree of the pixel from a reference line e.g., reference line 634. For example, a degree of a certain pixel can be determined by an angle between the line from the center to the corresponding pixel and the reference line. While gradient image 630-2 of FIG. 6A illustrates that direction lines range from 0° to 360° (i.e., degree range 360°) , it will be appreciated that the degree range can be different according to pattern shape, gradient image 630-2, etc. For example, a certain pattern may have a degree range less than 360°.

According to some embodiments of the present disclosure, a position of each pixel in section 633 can be determined according to distance information and degree information of section 633. For example, a position of a pixel can be specified as a distance from pattern contour 621 and a degree from a reference line. While some embodiments of the present disclosure are illustrated using a circular pattern (e.g., pattern 611), it will be appreciated that the present disclosure can be applied to any shape of patterns having a closed loop pattern. For example, a pixel in a section having any closed loop pattern can be specified by defining the location of the pixel in the section with the distance from the pattern contour and the degree from the reference line. In this disclosure, the close loop pattern can comprise any polygon type pattern, e.g., a rectangular pattern, a star shape pattern, etc. In some embodiments, the close loop pattern can also comprise a line pattern as the line pattern also has a width as well as a length.

Referring back to FIG. 5, gray level profile generator 540 can generate gray level profile data corresponding to inspection image 610. According to some embodiments of the present disclosure, gray level profile generator 540 can extract gray level profile data of inspection image 610 according to pattern information estimated in pattern information estimator 530. In some embodiments of the present disclosure, gray level profile generator 540 can extract gray level profile data according to distance information and degree information of each pattern obtained in pattern information estimator 530. FIG. 6B illustrates a gray level distribution 640 corresponding to section 612 including pattern 611 in inspection image 610. As shown in FIG. 6B, gray level profile data for section 612 can be extracted along a direction line 643 from rotation center 641 at a certain degree θ from reference line 642 within the degree range (e.g.,) 360° estimated in pattern information estimator 530. According to some embodiments of the present disclosure, gray level profile data for section 612 can be extracted along multiple direction lines 643 at various degrees θ from reference line 642. For example, gray level profile data for section 612 can be extracted along multiple direction lines 643 rotated by an equal angle.

FIG. 6C illustrates gray level profile data 645 extracted from gray level distribution 640 corresponding to section 612 including pattern 611 in inspection image 610. In FIG. 6C, an x-axis represents a distance from contour 621 of pattern 611 where distance 0 represents contour 621 of pattern 611 and the distance with the negative symbol (−) represents a distance from contour 621 of pattern 611 inside of the pattern and the distance with the positive symbol (+) represents a distance from contour 621 of pattern 611 outside of the pattern. In FIG. 6C, a y-axis represents a gray level value. In FIG. 6C, gray level values are sampled along direction line 643 in every rotation angle 10°. For example, gray level values of direction line 643 when degree θ equals 0° are indicated as a greyscale mark next to numerical number “0,” gray level values of direction line 643 when degree θ equals 10° are indicated as a greyscale mark next to numerical number “1,” and similarly gray level values of direction line 643 when degree θ equals 350° are indicated as a greyscale mark next to numerical number “35.”

As shown in FIG. 6C, gray level values of each direction line 643 can be modeled as a gray level profile along corresponding direction line 643. According to some embodiments of the present disclosure, a gray level profile for each direction line 643 can be modeled by mean and standard deviation of gray level values of pixels positioned along direction line 643. In this example, each section 612 can have 36 gray level profiles along 36 direction lines 643. According to some embodiments of the present disclosure, a gray level profile of section 612 can be modeled by mean and standard deviation of gray level values of pixels positioned along 36 direction lines 643. In this example, the gray level profile can be generated as two-dimension data. While extracting gray level profile data of section 612 of inspection image 610 along 36 direction lines 643 is illustrated in this disclosure, it will be appreciated that gray level profile data of inspection image can be extracted along any number of lines in any shape according to embodiments, a pattern shape, target accuracy, etc.

According to some embodiments of the present disclosure, a gray level profile can be modeled per pixel on pattern 611. In some embodiments, it can be assumed that a gray level profile of the same pattern follows a Gaussian distribution. In some embodiments, gray level values of pixels on multiple same patterns can be extracted from corresponding gray level distributions. For example, inspection image 610 includes a plurality of repeated patterns 611, e.g., N number of patterns 611, and gray level values of pixels on N number of patterns 611 can be extracted. In some embodiments, it is assumed that gray level values of N number of pixels at the corresponding position on N number of patterns 611 follow a Gaussian distribution. As described referring to FIG. 6A, each pixel's position on each pattern 611 can be specified by a distance from the pattern contour and a degree from the reference line. Therefore, for each relative pixel position on pattern 611, N number of gray level values can be extracted from N number of patterns 611. In some embodiments, a gray level profile for each relative pixel position on pattern 611 can be modeled by fitting a Gaussian distribution model to N number of extracted gray level values. For example, a Gaussian distribution model that can be obtained by fitting to extracted gray level values may be represented by Equation (1):

$$f ( x ) = \frac{1}{σ \sqrt{2 π}} {e}^{\frac{- {( x - μ )}^{2}}{2 {σ}^{2}}} \qquad Eq . ( 1 )$$

In Equation (1), x represents a position of a pixel on pattern 611, μ represents Gaussian distribution model's mean, and σ represents Gaussian distribution model's standard deviation. Position x can be represented by a distance from the pattern contour and a degree from the reference line. Mean μ and standard deviation σ can be obtained by fitting of a Gaussian distribution to N number of extracted gray level values on position x. Similarly, a gray level profile can be modeled for the rest of pixel positions on pattern 611. According to some embodiments of the present disclosure, each pixel position on pattern 611 can have a corresponding gray level profile following a Gaussian distribution. In some embodiments, each pixel position on pattern 611 can be modeled by a Gaussian distribution with associated mean μ or standard deviation σ. In some embodiments, Gaussian distributions representing gray level profiles for different pixel positions can have different mean μ or standard deviation σ. While obtaining gray level profiles of pixels on pattern 611 has been described, it will be appreciated that gray level profiles of pixels on an area (e.g., section 612) comprising pattern 611 and a surrounding area can be obtained in some embodiments. While modeling a gray level profile of pattern 611 based on the multiple patterns on one image, it will be appreciated that a gray level profile of a pattern can be modeled based on multiple patterns from multiple images.

According to some embodiments of the present disclosure, it is assumed that similar or same patterns have a similar or same gray level profile. According to some embodiments of the present disclosure, a gray level profile developed for one pattern (e.g., pattern 611) can be utilized to simulate an inspection image corresponding to design data (e.g., design data 410) having the similar or same patterns in terms of a pattern shape, size, or density. When applying gray level profile data to simulate an inspection image having the similar or same pattern, a gray level value for each pixel on pattern 611 can be randomly selected from a corresponding Gaussian distribution model based on probability, system requirement, etc. For example, when simulating an inspection image comprising 100 pixels, 100 gray level values can be selected from corresponding 100 Gaussian distribution models for a pattern (e.g., pattern 611).

According to some embodiments of the present disclosure, gray level profile data can also be obtained based on simulation images from a physical model-based simulator, e.g., Hyperlith, eScatter, etc. In some embodiments, gray level profile data can be user defined gray level profile data, e.g., using

Fraser model. In some embodiments, existing gray level profile data developed from SCPM images having different patterns, sizes, or densities from that of design data 410 can be utilized to simulate an inspection image corresponding to design data 410. In this case, the existing gray level profile data can be modified according to differences between design data 410 and SCPM images from which the existing gray level profile data is extracted when rendering an image corresponding to design data 410. Therefore, inspection images with various patterns, sizes, densities, etc. can be simulated according to some embodiments of the present disclosure.

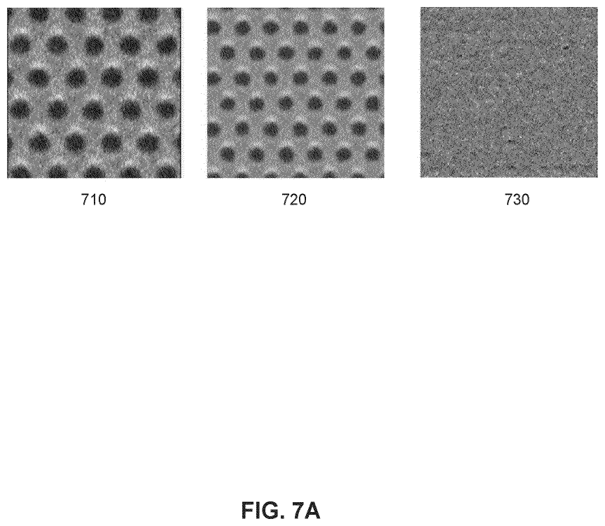

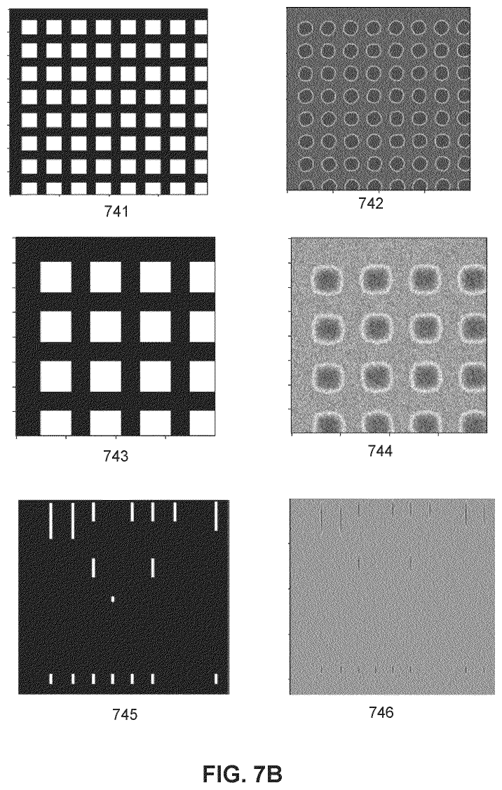

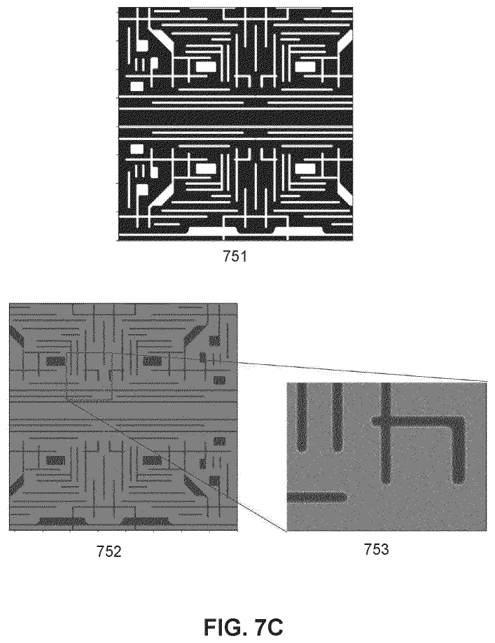

FIG. 7A illustrates an example performance evaluation of inspection image simulation system consistent with embodiments of the present disclosure. In FIG. 7A, a first image is a real SCPM image 710, a second image is a simulation image 720, and a third image is a residual image 730 that is acquired by subtracting simulation image 720 from real SCPM image 710. In this example, simulation image 720 is generated by inspection image simulation system 300 of FIG. 3 to incorporate parameters (e.g., distortions, voltage contrast pattern, gray level profile, etc.) of SCPM image 710. As shown in FIG. 7A, residual image 730 does not contain pattern related fingerprint features. It will be appreciated that pattern related features, e.g., pattern contour, a critical dimension, roughness, etc. can be accurately captured from simulation image 720 generated by inspection image simulation system 300 according to embodiments of the present disclosure.

FIGS. 7B-7C illustrate example simulation images of various patterns generated using inspection image simulation system consistent with embodiments of the present disclosure. In FIG. 7B, images on the left column are design data 741, 743, and 745 having various patterns and density and in a binary format. Images on the right column in FIG. 7B are simulation images 742, 744, and 746 generated by inspection image simulation system 300 of FIG. 3 based on corresponding design data 741, 743, and 745 on its left side respectively. Similarly, FIG. 7C illustrates design data 751 and its corresponding simulation image 752 generated by inspection image simulation system 300 of FIG. 3. FIG. 7C further illustrates an enlarged image 753 of a portion of simulation image 752. As shown in FIGS. 7B-7C, it is noted that inspection image simulation techniques of the present disclosure can be applied to various patterns and density, including but not limited to, line patterns (e.g., design pattern 745), complicated circuit pattern (e.g., design pattern 752), etc.

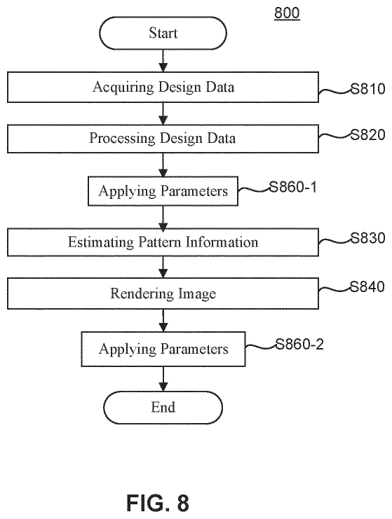

FIG. 8 is a process flowchart representing an example method for simulating inspection image, consistent with embodiments of the present disclosure. For illustrative purpose, a method for simulating inspection image will be described referring to inspection image simulation system 300 of FIG. 3.

In step S810, design data can be acquired. Step S810 can be performed by, for example, design data acquirer 310, among others. In some embodiments, design data can be a layout file for a wafer design, which is a golden image or in a Graphic Database System (GDS) format, Graphic Database System II (GDS II) format, an Open Artwork System Interchange Standard (OASIS) format, a Caltech Intermediate Format (CIF), etc. The wafer design may include patterns or structures for inclusion on the wafer. The patterns or structures can be mask patterns used to transfer features from the photolithography masks or reticles to a wafer. In some embodiments, a layout in GDS or OASIS format, among others, may comprise feature information stored in a binary file format representing planar geometric shapes, text, and other information related to the wafer design. As shown in FIG. 4A, design data 410 includes a pattern 411. In some embodiments, design data 410 can be generated to include pattern(s) with a designated shape, size, density, etc. In some embodiments, a certain portion of design data 410 having pattern(s) with a designated shape, size, density, etc. can be selected.

In step S820, design data can be processed. Step S820 can be performed by, for example, design data processor 310, among others. In some embodiments, design data 410 can be transformed into a binary image. In some embodiments, a corner rounding can be performed on the binary image. FIG. 4A illustrates a binary image 420, which is obtained after performing a corner rounding on a binary image transformed from design data 410. In some embodiments, a corner rounding operation can be performed to emulate a pattern formed on a wafer. In some embodiments, pattern merging or pattern cropping can further be performed on binary image 420.

According to some embodiments of the present disclosure, one or more parameters can be applied to incorporate properties that real SCPM images would have. According to some embodiments of the present disclosure, method 800 can take into account parameters to emulate SCPM images including certain metrology related properties such as roughness, charging effect, distortion, gray level profile, voltage contrast, etc. Method 800 can optionally include step S860-1. In step S860-1, one or more parameters can be applied to binary image 420. Step S820 can be performed by, for example, parameter applier 360, among others. In step S860-1, a charging effect can be applied to binary image 420. A charging effect can cause image distortion when structures of wafer comprise insulating materials. An image distortion model 360-1 representing the charging effect over binary image 420 can be applied to binary image 420. In some embodiments, image distortion model 360-1 representing a distortion map can be adjusted by changing parameters related to a rotation degree, a scale, shift, etc. FIG. 4A illustrates processed binary image 425, which is obtained after applying image distortion model 360-1 to binary image 420.

In step S830, pattern information can be estimated from processed binary image 425. Step S830 can be performed by, for example, pattern information estimator 330, among others. In some embodiments, in step S830, distance information and degree information of pattern 426 can be estimated. Detailed descriptions for estimating distance information and degree information will be omitted here for simplicity and conciseness as estimating distance information and degree information has been illustrated with respect to FIG. 4B. According to some embodiments of the present disclosure, a position of each pixel in section 433 can be determined according to distance information and degree information of section 433. For example, a position of a pixel can be specified as a distance from the contour of pattern 426 and a degree from a reference line.

In step S840, an image can be rendered using gray level profile data. Step S840 can be performed by, for example, image renderer 340, among others. In some embodiments, a gray level image corresponding to processed binary image 425 can be rendered using gray level profile data corresponding to processed binary image 420. Detailed descriptions for rendering an image corresponding to processed binary image 420 will be omitted here for simplicity and conciseness as rendering an image has been illustrated with respect to FIG. 4C. According to some embodiments of the present disclosure, gray level profile data 340-1 can be developed from real SCPM images, simulation images from physical model-based simulators, or user defined gray level profile data. How the gray level profile data is developed has been explained in the present disclosure referring to FIG. 5., therefore its detailed explanation will be omitted for clarity and simplicity. In some embodiments, gray level profile data 340-1 can be modified from gray level profile data extracted from real SCPM images or simulation images from physical model-based simulators, or from user defined gray level profile data. When modifying the existing gray level profile data, a user can change gray level profiles to reflect properties that a user intends to observe from inspection images. In some embodiments, existing gray level profile data developed from SCPM images having different patterns, sizes, or densities from that of design data 410 can be utilized to simulate an inspection image corresponding to design data 410. In this case, the existing gray level profile data can be modified according to differences between design data 410 and SCPM images from which the existing gray level profile data is extracted when rendering an image corresponding to design data 410.

Method 800 can optionally include step S860-2. In step S860-2, one or more parameters can be applied to gray level image 440. Step S860-2 can be performed by, for example, parameter applier 360, among others. In step S860-2, a charging effect can be applied to each section 441 on gray level image 440. According to some embodiments, a model representing a charging effect can be applied to gray level image 440. In some embodiments, a charging effect can lead to a darker or brighter voltage contrast on SCPIM image. In some embodiments, a model representing a charging effect can be generated according to materials forming structures on wafer, a pattern shape, intensity of irradiated beams, a scanning direction, etc. In some embodiments, parameter applier 360 can apply a model representing a charging effect for each section 441 on gray level image 440. In some embodiments, the model representing a charging effect can be adjusted by adjusting parameters related to a charging direction, a tail-length, etc. FIG. 4C illustrates a resultant gray level image 450 after a charging effect is applied.

In some embodiments, resultant gray level image 450 can be outputted as output data 350 of system 300. In some embodiments, one or more parameters can be applied to resultant gray level image 450 and output data therefrom can be outputted as output data 350 of system 300. In some embodiments, output data 350 can be packed in a certain image format including identification information of a pattern shape, size, density, etc. In some embodiments, output data 350 can be in any other format that can be used in later process, e.g., by a metrology tool.

A non-transitory computer readable medium may be provided that stores instructions for a processor of a controller (e.g., controller 109 of FIG. 1) to carry out, among other things, image inspection, image acquisition, stage positioning, beam focusing, electric field adjustment, beam bending, condenser lens adjusting, activating charged-particle source, beam deflecting, and methods 800. Common forms of non-transitory media include, for example, a floppy disk, a flexible disk, hard disk, solid state drive, magnetic tape, or any other magnetic data storage medium, a Compact Disc Read Only Memory (CD-ROM), any other optical data storage medium, any physical medium with patterns of holes, a Random Access Memory (RAM), a Programmable Read Only Memory (PROM), and Erasable Programmable Read Only Memory (EPROM), a FLASH-EPROM or any other flash memory, Non-Volatile Random Access Memory (NVRAM), a cache, a register, any other memory chip or cartridge, and networked versions of the same.

The embodiments may further be described using the following clauses:
1. A method for generating a simulated inspection image, comprising:
acquiring design data including a first pattern;
generating a first gray level profile corresponding to the design data; and
rendering an image using the generated first gray level profile.
2. The method of clause 1, wherein the first gray level profile is developed from a non-simulation inspection image, from a simulation image generated by a physical model-based simulator, or from a user defined gray level profile.
3. The method of clause 1 or 2, wherein generating the first gray level profile comprises:
acquiring a non-simulation inspection image having a second pattern;
extracting a pattern contour from the non-simulation inspection image;
estimating pattern information of the extracted pattern contour;
generating a second gray level profile corresponding to the non-simulation inspection image based on
the estimated pattern information; and
generating the first gray level profile by modifying the second gray level profile based on a difference between the first pattern and the second pattern.
4. The method of clause 3, wherein the first pattern and the second pattern are different in size, shape, or density.
5. The method of clause 3 or 4, wherein generating the second gray level profile comprising:
modeling a gray level profile of a pixel on the second pattern using a Gaussian distribution model based on gray level values of pixels at a corresponding position on multiple patterns having the same pattern as the second pattern.
6. The method of any one of clauses 3-5, wherein the pattern information includes distance information and degree information of the second pattern.
7. The method of clause 6, wherein the distance information and the degree information are used to define a position of a pixel on the second pattern.
8. The method of clause 1 or 2, wherein generating the first gray level profile comprises:
generating a second gray level profile corresponding to a second pattern;
generating the first gray level profile by modifying the second gray level profile based on a difference between the first pattern and the second pattern.
9. The method of any one of clauses 1-8, further comprising:
incorporating a user defined parameter into the image.
10. The method of clause 9, wherein incorporating the user defined parameter comprises:
performing a corner rounding on the design data including the first pattern;
applying an image distortion to the design data; or
applying a charging effect on the rendered image.
11. A method for generating a simulated inspection image, comprising:
acquiring a non-simulation inspection image having a first pattern;
extracting a pattern contour from the non-simulation inspection image;
estimating pattern information of the extracted pattern contour;
generating a first gray level profile corresponding to the non-simulation inspection image based on the estimated pattern information; and
generating a first gray level profile by modifying the second gray level profile.
12. The method of clause 11, wherein generating the first gray level profile comprising:
modeling a gray level profile of a pixel on the first pattern using a Gaussian distribution model based on gray level values of pixels at a corresponding position on multiple patterns having the same pattern as the first pattern.
13. The method of clause 11 or 12, wherein the pattern information includes distance information and degree information of the first pattern.
14. The method of clause 13, wherein the distance information and the degree information are used to define a position of a pixel on the first pattern.
15. The method of any one of clauses 11-13, further comprising:
acquiring design data including a second pattern; and
rendering an image using the generated first gray level profile.
16. The method of clause 15, wherein the first pattern and the second pattern are different in size, shape, or density.
17. The method of any one of clauses 11-16, further comprising:
incorporating a user defined parameter into the image.
18. The method of clause 17, wherein incorporating the user defined parameter comprises:
performing a corner rounding on the design data including the second pattern;
applying an image distortion to the design data; or
applying a charging effect on the rendered image.
19. An apparatus for generating a simulated inspection image, comprising:
a memory storing a set of instructions; and
at least one processor configured to execute the set of instructions to cause the apparatus to perform:
acquiring design data including a first pattern;
generating a first gray level profile corresponding to the design data; and
rendering an image using the generated first gray level profile.
20. The apparatus of clause 19, wherein the first gray level profile is developed from a non-simulation inspection image, from a simulation image generated by a physical model-based simulator, or from a user defined gray level profile.
21. The apparatus of clause 19 or 20, wherein, in generating the first gray level profile, the at least one processor is configured to execute the set of instructions to cause the apparatus to further perform:
acquiring a non-simulation inspection image having a second pattern;
extracting a pattern contour from the non-simulation inspection image;
estimating pattern information of the extracted pattern contour;
generating a second gray level profile corresponding to the non-simulation inspection image based on the estimated pattern information; and
generating the first gray level profile by modifying the second gray level profile based on a difference between the first pattern and the second pattern.
22. The apparatus of clause 21, wherein the first pattern and the second pattern are different in size, shape, or density.
23. The apparatus of clause 21 or 22, wherein, in generating the second gray level profile, the at least one processor is configured to execute the set of instructions to cause the apparatus to perform:
modeling a gray level profile of a pixel on the second pattern using a Gaussian distribution model based on gray level values of pixels at a corresponding position on multiple patterns having the same pattern as the second pattern.
24. The apparatus of any one of clauses 21-23, wherein the pattern information includes distance information and degree information of the second pattern.
25. The apparatus of clause 24, wherein the distance information and the degree information are used to define a position of a pixel on the second pattern.
26. The apparatus of clause 19 or 20, wherein, in generating the first gray level profile, the at least one processor is configured to execute the set of instructions to cause the apparatus to further perform:
generating a second gray level profile corresponding to a second pattern;
generating the first gray level profile by modifying the second gray level profile based on a difference between the first pattern and the second pattern.
27. The apparatus of any one of clauses 19-26, wherein the at least one processor is configured to execute the set of instructions to cause the apparatus to further perform:
incorporating a user defined parameter into the image.
28. The apparatus of clause 27, wherein, in incorporating the user defined parameter, the at least one processor is configured to execute the set of instructions to cause the apparatus to perform:
performing a corner rounding on the design data including the first pattern;
applying an image distortion to the design data; or
applying a charging effect on the rendered image.
29. An apparatus for generating a simulated inspection image, comprising:
a memory storing a set of instructions; and
at least one processor configured to execute the set of instructions to cause the apparatus to perform:
acquiring a non-simulation inspection image having a first pattern;
extracting a pattern contour from the non-simulation inspection image;
estimating pattern information of the extracted pattern contour;
generating a first gray level profile corresponding to the non-simulation inspection image based on the estimated pattern information; and
generating a first gray level profile by modifying the second gray level profile.
30. The apparatus of clause 29, wherein, in generating the first gray level profile, the at least one processor is configured to execute the set of instructions to cause the apparatus to perform:
modeling a gray level profile of a pixel on the first pattern using a Gaussian distribution model based on gray level values of pixels at a corresponding position on multiple patterns having the same pattern as the first pattern.
31. The apparatus of clause 29 or 30, wherein the pattern information includes distance information and degree information of the first pattern.
32. The apparatus of clause 31, wherein the distance information and the degree information are used to define a position of a pixel on the first pattern.
33. The apparatus of any one of clauses 29-32, wherein the at least one processor is configured to execute the set of instructions to cause the apparatus to further perform:
acquiring design data including a second pattern; and
rendering an image using the generated first gray level profile.
34. The apparatus of clause 33, wherein the first pattern and the second pattern are different in size, shape, or density.
35. The apparatus of any one of clauses 29-34, wherein the at least one processor is configured to execute the set of instructions to cause the apparatus to further perform:
incorporating a user defined parameter into the image.
36. The apparatus of clause 35, wherein, in incorporating the user defined parameter, the at least one processor is configured to execute the set of instructions to cause the apparatus to perform:
performing a corner rounding on the design data including the second pattern;
applying an image distortion to the design data; or
applying a charging effect on the rendered image.
37. A non-transitory computer readable medium that stores a set of instructions that is executable by at least on processor of a computing device to cause the computing device to perform a method for generating a simulated inspection image, the method comprising:
acquiring design data including a first pattern;
generating a first gray level profile corresponding to the design data; and
rendering an image using the generated first gray level profile.
38. The computer readable medium of clause 37, wherein the first gray level profile is developed from a non-simulation inspection image, from a simulation image generated by a physical model-based simulator, or from a user defined gray level profile.
39. The computer readable medium of clause 37 or 38, wherein, in generating the first gray level profile, the set of instructions that is executable by at least one processor of the computing device cause the computing device to perform:
acquiring a non-simulation inspection image having a second pattern;
extracting a pattern contour from the non-simulation inspection image;
estimating pattern information of the extracted pattern contour;
generating a second gray level profile corresponding to the non-simulation inspection image based on the estimated pattern information; and
generating the first gray level profile by modifying the second gray level profile based on a difference between the first pattern and the second pattern.
40. The computer readable medium of clause 39, wherein the first pattern and the second pattern are different in size, shape, or density.
41. The computer readable medium of clause 39 or 40, wherein, in generating the second gray level profile, the set of instructions that is executable by at least one processor of the computing device cause the computing device to perform:
modeling a gray level profile of a pixel on the second pattern using a Gaussian distribution model based on gray level values of pixels at a corresponding position on multiple patterns having the same pattern as the second pattern.
42. The computer readable medium of any one of clauses 39-41, wherein the pattern information includes distance information and degree information of the second pattern.
43. The computer readable medium of clause 42, wherein the distance information and the degree information are used to define a position of a pixel on the second pattern.
44. The computer readable medium of clause 37 or 38, wherein, in generating the first gray level profile, the set of instructions that is executable by at least one processor of the computing device cause the computing device to perform:
generating a second gray level profile corresponding to a second pattern;
generating the first gray level profile by modifying the second gray level profile based on a difference between the first pattern and the second pattern.
45. The computer readable medium of any one of clauses 37-44, wherein the set of instructions that is executable by at least one processor of the computing device cause the computing device to further perform:
incorporating a user defined parameter into the image.
46. The computer readable medium of clause 45, wherein, in incorporating the user defined parameter, the set of instructions that is executable by at least one processor of the computing device cause the computing device to perform:
performing a corner rounding on the design data including the first pattern;
applying an image distortion to the design data; or
applying a charging effect on the rendered image.
47. A non-transitory computer readable medium that stores a set of instructions that is executable by at least on processor of a computing device to cause the computing device to perform a method for generating a simulated inspection image, the method comprising:
acquiring a non-simulation inspection image having a first pattern;
extracting a pattern contour from the non-simulation inspection image;
estimating pattern information of the extracted pattern contour;
generating a first gray level profile corresponding to the non-simulation inspection image based on the estimated pattern information; and
generating a first gray level profile by modifying the second gray level profile.
48. The computer readable medium of clause 47, wherein, in generating the first gray level profile, the set of instructions that is executable by at least one processor of the computing device cause the computing device to perform:
modeling a gray level profile of a pixel on the first pattern using a Gaussian distribution model based on gray level values of pixels at a corresponding position on multiple patterns having the same pattern as the first pattern.
49. The computer readable medium of clause 47 or 48, wherein the pattern information includes distance information and degree information of the first pattern.
50. The computer readable medium of clause 49, wherein the distance information and the degree information are used to define a position of a pixel on the first pattern.
51. The computer readable medium of any one of clauses 47-50, wherein the set of instructions that is executable by at least one processor of the computing device cause the computing device to further perform:
acquiring design data including a second pattern; and
rendering an image using the generated first gray level profile.
52. The computer readable medium of clause 51, wherein the first pattern and the second pattern are different in size, shape, or density.
53. The computer readable medium of any one of clauses 47-52, wherein the set of instructions that is executable by at least one processor of the computing device cause the computing device to further perform:
incorporating a user defined parameter into the image.
54. The computer readable medium of clause 53, wherein, in incorporating the user defined parameter, the set of instructions that is executable by at least one processor of the computing device cause the computing device to perform:
performing a corner rounding on the design data including the second pattern;
applying an image distortion to the design data; or
applying a charging effect on the rendered image.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that comprises one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An apparatus for generating a simulated inspection image, comprising:
a memory storing a set of instructions; and
at least one processor configured to execute the set of instructions to cause the apparatus to perform:
acquiring design data including a first pattern;
generating a first gray level profile corresponding to the design data; and
rendering an image using the generated first gray level profile.

2. The apparatus of claim 1, wherein the first gray level profile is developed from a non-simulation inspection image, from a simulation image generated by a physical model-based simulator, or from a user defined gray level profile.

3. The apparatus of claim 1, wherein, in generating the first gray level profile, the at least one processor is configured to execute the set of instructions to cause the apparatus to further perform:
acquiring a non-simulation inspection image having a second pattern;
extracting a pattern contour from the non-simulation inspection image;
estimating pattern information of the extracted pattern contour;
generating a second gray level profile corresponding to the non-simulation inspection image based on the estimated pattern information; and
generating the first gray level profile by modifying the second gray level profile based on a difference between the first pattern and the second pattern.

4. The apparatus of claim 3, wherein the first pattern and the second pattern are different in size, shape, or density.

5. The apparatus of claim 3, wherein, in generating the second gray level profile, the at least one processor is configured to execute the set of instructions to cause the apparatus to perform:
modeling a gray level profile of a pixel on the second pattern using a Gaussian distribution model based on gray level values of pixels at a corresponding position on multiple patterns having the same pattern as the second pattern.

6. The apparatus of claim 3, wherein the pattern information includes distance information and degree information of the second pattern.

7. The apparatus of claim 6, wherein the distance information and the degree information are used to define a position of a pixel on the second pattern.

8. The apparatus of claim 1, wherein, in generating the first gray level profile, the at least one processor is configured to execute the set of instructions to cause the apparatus to further perform:
generating a second gray level profile corresponding to a second pattern;
generating the first gray level profile by modifying the second gray level profile based on a difference between the first pattern and the second pattern.

9. The apparatus of claim 1, wherein the at least one processor is configured to execute the set of instructions to cause the apparatus to further perform:
incorporating a user defined parameter into the image.

10. The apparatus of claim 9, wherein, in incorporating the user defined parameter, the at least one processor is configured to execute the set of instructions to cause the apparatus to perform:
performing a corner rounding on the design data including the first pattern;
applying an image distortion to the design data; or
applying a charging effect on the rendered image.

11. A non-transitory computer readable medium that stores a set of instructions that is executable by at least one processor of a computing device to cause the computing device to perform a method for generating a simulated inspection image, the method comprising:
acquiring design data including a first pattern;
generating a first gray level profile corresponding to the design data; and
rendering an image using the generated first gray level profile.

12. The computer readable medium of claim 11, wherein the first gray level profile is developed from a non-simulation inspection image, from a simulation image generated by a physical model-based simulator, or from a user defined gray level profile.

13. The computer readable medium of claim 11, wherein, in generating the first gray level profile, the set of instructions that is executable by at least one processor of the computing device cause the computing device to perform:
acquiring a non-simulation inspection image having a second pattern;
extracting a pattern contour from the non-simulation inspection image;
estimating pattern information of the extracted pattern contour;
generating a second gray level profile corresponding to the non-simulation inspection image based on the estimated pattern information; and
generating the first gray level profile by modifying the second gray level profile based on a difference between the first pattern and the second pattern.

14. The computer readable medium of claim 13, wherein the first pattern and the second pattern are different in size, shape, or density.

15. The computer readable medium of claim 13, wherein, in generating the second gray level profile, the set of instructions that is executable by at least one processor of the computing device cause the computing device to perform:
modeling a gray level profile of a pixel on the second pattern using a Gaussian distribution model based on gray level values of pixels at a corresponding position on multiple patterns having the same pattern as the second pattern.

16. The computer readable medium of claim 13, wherein the pattern information includes distance information and degree information of the second pattern.

17. The computer readable medium of claim 16, wherein the distance information and the degree information are used to define a position of a pixel on the second pattern.

18. The computer readable medium of claim 11, wherein, in generating the first gray level profile, the set of instructions that is executable by at least one processor of the computing device cause the computing device to perform:
generating a second gray level profile corresponding to a second pattern;
generating the first gray level profile by modifying the second gray level profile based on a difference between the first pattern and the second pattern.

19. The computer readable medium of claim 11, wherein the set of instructions that is executable by at least one processor of the computing device cause the computing device to further perform:
incorporating a user defined parameter into the image.

20. A method for generating a simulated inspection image, comprising:
acquiring design data including a first pattern;
generating a first gray level profile corresponding to the design data; and
rendering an image using the generated first gray level profile.
